(19) United States
(12) Patent Application Publication
(10) Pub. No.: US 2023/0296397 A1
(43) Pub. Date: Sep. 21, 2023

(54) INFORMATION PROCESSING APPARATUS, MANAGEMENT APPARATUS, AND INFORMATION PROCESSING SYSTEM

(71) Applicants: Izumi Itoh, Tokyo (JP); Shuuichi Nakamura, Kanagawa (JP); Ken Nagai, Kanagawa (JP); Kohji Oshikiri, Kanagawa (JP)

(72) Inventors: Izumi Itoh, Tokyo (JP); Shuuichi Nakamura, Kanagawa (JP); Ken Nagai, Kanagawa (JP); Kohji Oshikiri, Kanagawa (JP)

(73) Assignee: Ricoh Company, Ltd., Tokyo (JP)

(21) Appl. No.: 18/181,056

(22) Filed: Mar. 9, 2023

(30) Foreign Application Priority Data
Mar. 18, 2022 (JP) 2022-044087
Mar. 22, 2022 (JP) 2022-045111
Feb. 27, 2023 (JP) 2023-028191

(51) Int. Cl. G01C 21/36; G06T 7/00

(52) U.S. Cl. CPC G01C 21/3697; G06T 7/0002; G06T 2207/10012; G06T 2207/30256; G01C 21/3602

(57) ABSTRACT

An information processing apparatus includes circuitry. The circuitry controls a display to display primary analysis information obtained by analyzing measurement information without being based on a request for an analysis. The measurement information is obtained by measuring an object. The circuitry accepts an analysis request that requests secondary analysis information of the measurement information corresponding to the primary analysis information.

### CROSS-REFERENCE TO RELATED APPLICATIONS

This patent application is based on and claims priority pursuant to 35 U.S.C. § 119(a) to Japanese Patent Application Nos. 2022-044087, filed on Mar. 18, 2022, 2022-045111, filed on Mar. 22, 2022, and 2023-028191, filed on Feb. 27, 2023, in the Japan Patent Office, the entire disclosures of which are hereby incorporated by reference herein.

### BACKGROUND

### Technical Field

Embodiments of the present disclosure relate to an information processing apparatus, a management apparatus, and an information processing system.

### Related Art

A road condition management system is known that identifies, on the basis of latitude and longitude information of a location where damage has occurred, an identifier (ID) and a distance post of a road closest to the corresponding latitude and longitude and displays a mark indicating that damage has occurred on the corresponding road on a map accompanied with a value of the distance post.

### SUMMARY

An embodiment of the present disclosure includes an information processing apparatus including circuitry. The circuitry controls a display to display primary analysis information obtained by analyzing measurement information without being based on a request for an analysis. The measurement information is obtained by measuring an object. The circuitry accepts an analysis request that requests secondary analysis information of the measurement information corresponding to the primary analysis information.

An embodiment of the present disclosure includes a management apparatus including circuitry. The circuitry stores, in a memory, primary analysis information obtained by analyzing measurement information without being based on a request for an analysis. The measurement information is obtained by measuring an object. The circuitry transmits the primary analysis information to a terminal apparatus. The circuitry receives, from the terminal apparatus, an analysis request that requests secondary analysis information of the measurement information corresponding to the primary analysis information.

An embodiment of the present disclosure includes an information processing system including a management apparatus and a terminal apparatus communicably connected to the management apparatus. The management apparatus includes first circuitry. The first circuitry stores, in a memory, primary analysis information obtained by analyzing measurement information without being based on a request for an analysis. The measurement information is obtained by measuring an object. The first circuitry transmits the primary analysis information to the terminal apparatus. The first circuitry receives, from the terminal apparatus, an analysis request that requests secondary analysis information of the measurement information corresponding to the primary analysis information. The terminal apparatus includes second circuitry. The second circuitry receives the primary analysis information from the management apparatus. The second circuitry controls a display to display the received primary analysis information. The second circuitry accepts the analysis request. The second circuitry transmits the analysis request to the management apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an overall configuration of a state inspection system, according to according to an embodiment of the present disclosure;

FIG. 2 is a block diagram illustrating an example of a hardware configuration of a data acquisition apparatus, according to an embodiment of the present disclosure;

FIG. 3 is a block diagram illustrating an example of a hardware configuration of each of a management apparatus and an analysis apparatus, according to an embodiment of the present disclosure;

FIG. 4 is a block diagram illustrating an example of a functional configuration of the state inspection system, according to an embodiment of the present disclosure;

FIG. 5 is a conceptual diagram illustrating an example of an analysis information management table, according to an embodiment of the present disclosure;

FIG. 6 is a sequence diagram illustrating an example of an operation of analyzing data, according to an embodiment of the present disclosure; and

FIG. 7 is a flowchart illustrating an example of an operation of updating measurement information, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described with reference to the drawings. In the description of the drawings, the same elements are denoted by the same reference numerals, and redundant descriptions thereof are omitted.

### Embodiments

Overview of System

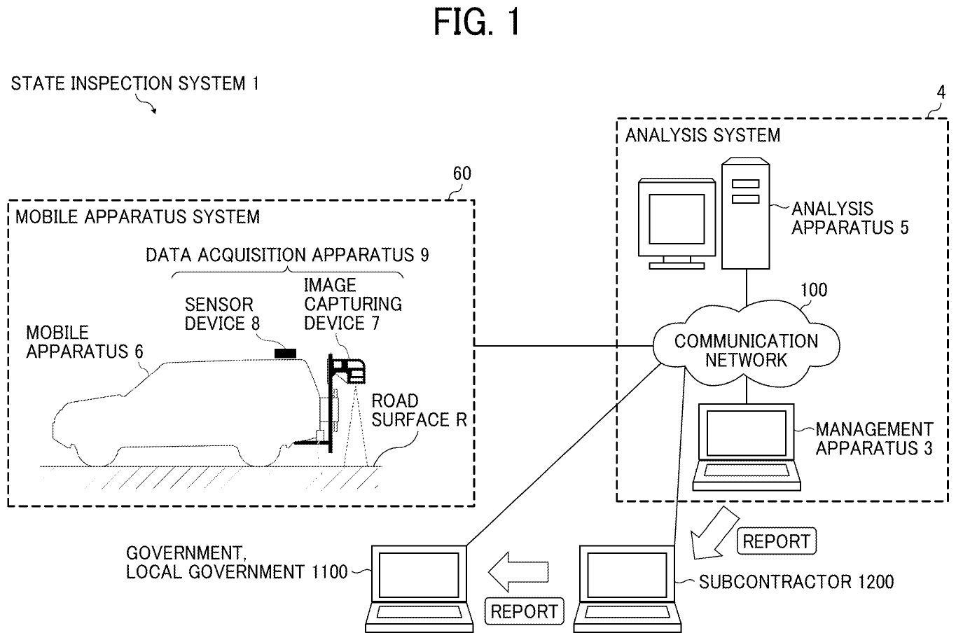

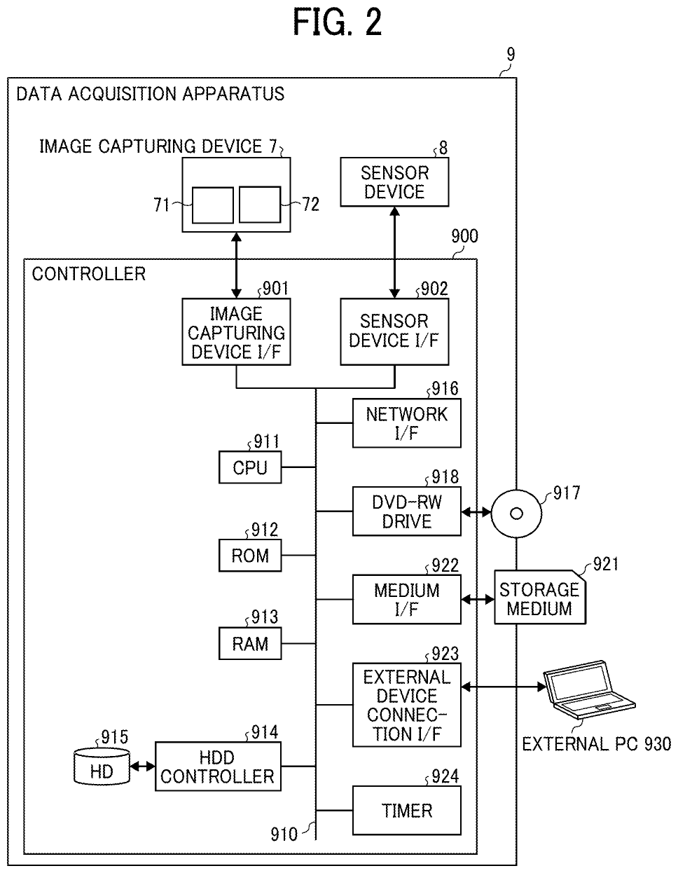

Referring to FIG. 1 and FIG. 2, an overview of a state inspection system 1 is described according to an embodiment. FIG. 1 is a schematic view illustrating an overall configuration of the state inspection system 1 according to an embodiment. The state inspection system 1 illustrated in FIG. 1 is an example of an information processing system. The state inspection system 1 measures and inspects properties such as a crack of a structure such as a road surface using various data acquired by a mobile apparatus system 60.

Examples of the structure include, but are not limited to, a sidewalk surface, a carriage way surface (road surface) on which vehicles travels, a railway on which trains travels, a slope, an inner surface of a tunnel, and a structure on a road. Examples of the structure on a road include, but are not limited to, a sign and a utility pole provided on a road edge. In the following description, a case of inspecting properties of a road surface on which a mobile apparatus 6 such as a vehicle travels is described. The state inspection system 1 is used, for example, for a case of inspecting a surface property of a structure that extends in one direction on a section-by-section basis, each section having a certain distance.

The state inspection system 1 includes the mobile apparatus system 60, an analysis system 4, a communication terminal 1100 of a national government or a local government, and a communication terminal 1200 of a subcontractor. The mobile apparatus system 60 is an example of an image-capturing system. The mobile apparatus system 60 includes a data acquisition apparatus 9 and a mobile apparatus 6 such as a vehicle. The data acquisition apparatus 9 is mounted on the mobile apparatus 6. The data acquisition apparatus 9 is an example of a measurement apparatus. The data acquisition apparatus 9 includes an image capturing device 7 and a global navigation satellite system (GNSS) sensor. The image capturing device 7 is an example of a measuring device that measures a structure. GNSS is a term that collectively refers to satellite positioning systems such as a global positioning system (GPS) or quasi-zenith satellite (QZSS). The GNSS sensor is an example of a sensor device 8. The mobile apparatus system 60 photographs a structure such as a road surface while the mobile apparatus 6 travels.

The image capturing device 7 is provided, for example, at a rear portion of a roof of the mobile apparatus 6 so as to face in a direction opposite to the traveling direction of the mobile apparatus, and photographs a road surface R behind the mobile apparatus 6. In another example, the image capturing device 7 is provided, for example, at a front portion of the roof of the mobile apparatus 6 so as to face in the same direction as the traveling direction of the mobile apparatus. In another example, the image capturing device 7 is provided on a side portion of the roof of the mobile apparatus 6 so as to face in a direction perpendicular (or substantially perpendicular) to the traveling direction of the mobile apparatus. In another example, the image capturing device 7 is provided near the number plate in front of the mobile apparatus 6.

The image capturing device 7 is a stereo camera that photographs a predetermined range of the road surface R. The stereo camera is, for example, a camera for obtaining depth information of unevenness or the like formed on the road surface R to be analyzed by using parallax information of two cameras arranged side by side. The stereo camera repeatedly performs photographing at a timing at which parts of images overlap with each other in the traveling direction of the mobile apparatus 6. It is preferable that only one stereo camera is installed in consideration of mounting on the mobile apparatus 6. In order to deal with a road having a wide road surface width, multiple stereo cameras may be installed so as to photograph the entire road surface R in the width direction, and the multiple stereo cameras may concurrently perform photographing so that parts of images overlap in the width direction. In this case, the multiple stereo cameras are aligned in a row so that they face the road surface R obliquely downward.

The mobile apparatus 6 is, for example, a dedicated vehicle. In another example, the mobile apparatus 6 is a general-purpose vehicle such as a parcel delivery vehicle. The general-purpose vehicle installed with the image capturing device 7 implements photographing while traveling and measurement of data capable of outputting a crack, rutting, flatness, and International Roughness Index (IRI) without the cost that is required when using the dedicated vehicle. In a case that a single stereo camera is used, the stereo camera can be easily mounted when the mobile apparatus 6 is a general-purpose vehicle.

The analysis system 4 includes a management apparatus 3 and an analysis apparatus 5. The management apparatus 3 and the analysis apparatus 5 of the analysis system 4 are communicably connected to the mobile apparatus system 60, the communication terminal 1100, and the communication terminal 1200 through a communication network 100. The communication network 100 includes the Internet, a mobile communication network, and a local area network (LAN), for example.

The communication network 100 includes a network by not only wired communications but also a network by wireless communications such as 3rd generation (3G), 4th generation (4G), 5th generation (5G), Wireless Fidelity (Wi-Fi®), Worldwide Interoperability for Microwave Access (WiMAX), or Long Term Evolution (LTE).

Further, the management apparatus 3 and the analysis apparatus 5 may have communication capability using a short-range communication technology such as near field communication (NFC®).

The analysis apparatus 5 is an example of an information processing apparatus. The analysis apparatus 5 is a computer such as a personal computer (PC) that analyzes various data acquired by the data acquisition apparatus 9. The analysis apparatus 5 is installed with a dedicated application program for analyzing a state of the road surface. In another example, the transfer of the various acquired data from the analysis apparatus 5 to the management apparatus 3 is performed manually, for example, using a universal serial bus (USB) memory.

The management apparatus 3 is a computer such as a PC that manages various analysis information transferred from the analysis apparatus 5. Further, the management apparatus 3 generates a report using captured image data, sensor data, analysis information, and detailed analysis result. The report is to be submitted to an entity that manages roads such as a national government, a local government, or a subcontractor. Data of the report generated by the management apparatus 3 is submitted to the national government or the local governments via the subcontractor in the form of electronic data or printed documents. The report generated by the management apparatus 3 is referred to as a “survey record sheet”, a “check list”, a “survey profile”, or “records”, for example. The PC is merely one example of the management apparatus 3. Alternatively, a smartphone, a tablet terminal, or the like may be used for the management apparatus 3. In another example, the management apparatus 3 and the analysis apparatus 5 of the analysis system 4 are constructed as a single apparatus or terminal.

The communication terminal 1200 is provided in the subcontractor. The communication terminal 1100 is provided in the national government or the local government. The management apparatus 3, the communication terminal 1100, and the communication terminal 1200 are examples of terminal apparatuses communicably connected to the analysis apparatus 5. Various data managed by the analysis apparatus 5 can be viewed at the management apparatus 3, the communication terminal 1100, and the communication terminal 1200.

Hardware Configuration

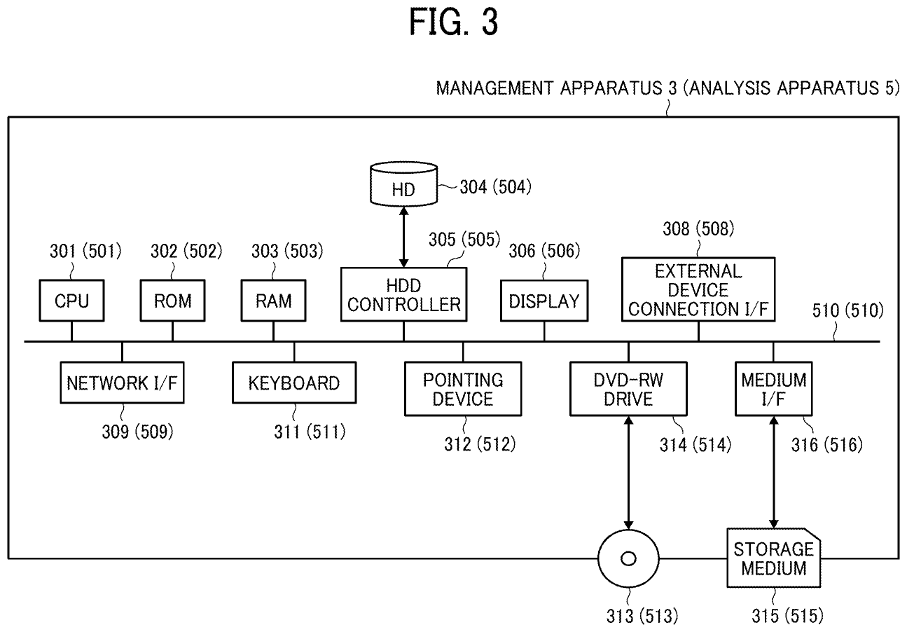

Referring to FIG. 2 and FIG. 3, a hardware configuration of each of the apparatuses of the state inspection system 1 is described. In the hardware configurations illustrated in FIG. 2 and FIG. 3, components or elements may be added or deleted as needed.

Hardware Configuration of Data Acquisition Apparatus

FIG. 2 is a block diagram illustrating an example of a hardware configuration of the data acquisition apparatus 9. The data acquisition apparatus 9 includes the image capturing device 7 and the sensor device 8 as illustrated in FIG. 1, and a controller 900 that controls processing or operation of the data acquisition apparatus 9.

The image capturing device 7 includes a first camera 71 and a second camera 72. The image capturing device 7 provides captured image data of the road surface R photographed by the first camera 71 and the second camera 72 to the controller 900.

Specifically, the image capturing device 7 provides brightness image data captured by each of the first camera 71 and the second camera 72 and parallax image data indicating parallax information by the first camera 71 and the second camera 72 to the controller 900.

Imaging processing by the first camera 71 and the second camera 72 of the image capturing device 7 is controlled by the controller 900. For example, the controller 900 configures settings of various parameters including exposure positions of the first camera 71 and the second camera 72, instructs the start and end of photographing, and records a captured image. The image capturing device 7 is preferably a single stereo camera including the first camera 71 and the second camera 72. In another example, the image capturing device 7 includes two or more stereo cameras.

The controller 900 includes an image capturing device interface (I/F) 901, a sensor device I/F 902, a bus line 910, a central processing unit (CPU) 911, a read only memory (ROM) 912, a random access memory (RAM) 913, a hard disk (HD) 914, a hard disk drive (HDD) controller 915, a network I/F 916, a digital versatile disk rewritable (DVD-RW) drive 918, a medium I/F 922, an external device connection I/F 923, and a timer 924.

The image capturing device I/F 901 is an interface through which the controller 900 transmits and receives various data or information to and from the image capturing device 7. The sensor device I/F 902 is an interface through which the controller 900 transmits and receives various data or information to and from the sensor device 8. Examples of the bus line 910 include, but are not limited to, an address bus and a data bus that electrically connects the components illustrated in FIG. 2 such as the CPU 911.

The CPU 911 controls overall operation of the data acquisition apparatus 9. The ROM 912 stores a program such as an initial program loader (IPL) to boot the CPU 911. The RAM 913 is used as a work area for the CPU 911. The HD 914 stores various data such as programs. The HDD controller 915 controls reading or writing of various data to or from the HD 914 under control of the CPU 911. The network I/F 916 is an interface that controls communication of data with an external device through the communication network 100.

The DVD-RW drive 918 controls reading or writing of various data to or from a DVD-RW 917, which is an example of a removable storage medium. In another example, the removable storage medium includes at least one of digital versatile disk-recordable (DVD-R) or a Blu-ray® disc, in addition to or in alternative to the DVD-RW.

The medium I/F 922 controls reading or writing (storing) of data from or to a storage medium 921 such as a flash memory. The external device connection I/F 923 is an interface that connects the data acquisition apparatus 9 to an external PC 930 including a display, an operation receiving device, and a display controller. The timer 924 is a measurement device that has a time measurement function. The timer 924 may be a computer-based software timer.

Hardware Configuration of Management Apparatus

FIG. 3 is a block diagram illustrating an example of a hardware configuration of the management apparatus 3. Hardware elements of the management apparatus 3 are given reference numerals in 300 series. As illustrated in FIG. 3, the management apparatus 3 is implemented by a computer. Specifically, the management apparatus 3 includes a CPU 301, a ROM 302, a RAM 303, an HD 304, an HDD controller 305, a display 306, an external device connection I/F 308, a network I/F 309, a bus line 310, a keyboard 311, a pointing device 312, a DVD-RW drive 314, and a medium I/F 316.

The CPU 301 controls overall operation of the management apparatus 3. The ROM 302 stores a program such as an IPL to boot the CPU 301. The RAM 303 is used as a work area for the CPU 301. The HD 304 stores various data such as programs. The HDD controller 305 controls reading or writing of various data to or from the HD 304 under control of the CPU 301. The display 306 displays various information such as a cursor, a menu, a window, characters, or an image. The display 306 is an example of a display unit.

The external device connection I/F 308 is an interface that connects the management apparatus 3 to various external devices. Examples of the external devices include, but are not limited to, a USB memory and a printer. The network I/F 309 is an interface that controls communication of data with an external device through the communication network 100. Examples of the bus line 310 include, but are not limited to, an address bus and a data bus that electrically connects the components illustrated in FIG. 3 such as the CPU 301.

The keyboard 311 is an example of input means (an input device) including a plurality of keys for inputting characters, numerical values, various instructions, and the like. The pointing device 312 is an example of input means (an input device) that allows a user to select or execute a specific instruction, select an object for processing, or move a cursor being displayed. The DVD-RW drive 314 controls reading or writing of various data to or from a DVD-RW 313, which is an example of a removable storage medium. In another example, the removable storage medium includes at least one of DVD-R or a Blu-ray® disc, in addition to or in alternative to the DVD-RW. The medium I/F 316 controls reading or writing (storing) of data from or to a storage medium 315 such as a flash memory.

Hardware Configuration of Analysis Apparatus

FIG. 3 is a block diagram illustrating an example of a hardware configuration of the analysis apparatus 5. Hardware elements of the analysis apparatus 5 are given reference numerals in 500 series. As illustrated in FIG. 3, the analysis apparatus 5 is implemented by a computer. As illustrated in FIG. 3, since the analysis apparatus 5 has the same configuration as the management apparatus 3, the description of the hardware configuration thereof is omitted below. Further, since each of the communication terminal 1100 and the communication terminal 1200 is also implemented by a computer and has the same or substantially the same configuration as that of the management apparatus 3, the description of the hardware configuration thereof is omitted below.

For example, each of the above-described programs is recorded in a file in a format installable or executable on a computer-readable storage medium for distribution. Examples of the storage medium include a compact disc recordable (CD-R), a DVD, a Blu-ray® disc, a secure digital (SD) card, and a USB memory. In addition, such storage medium may be provided in the domestic markets of foreign markets as program products. For example, the analysis system 4 according to an embodiment executes the program according to the present disclosure to implement an evaluation method according to the present disclosure.

Functional Configuration

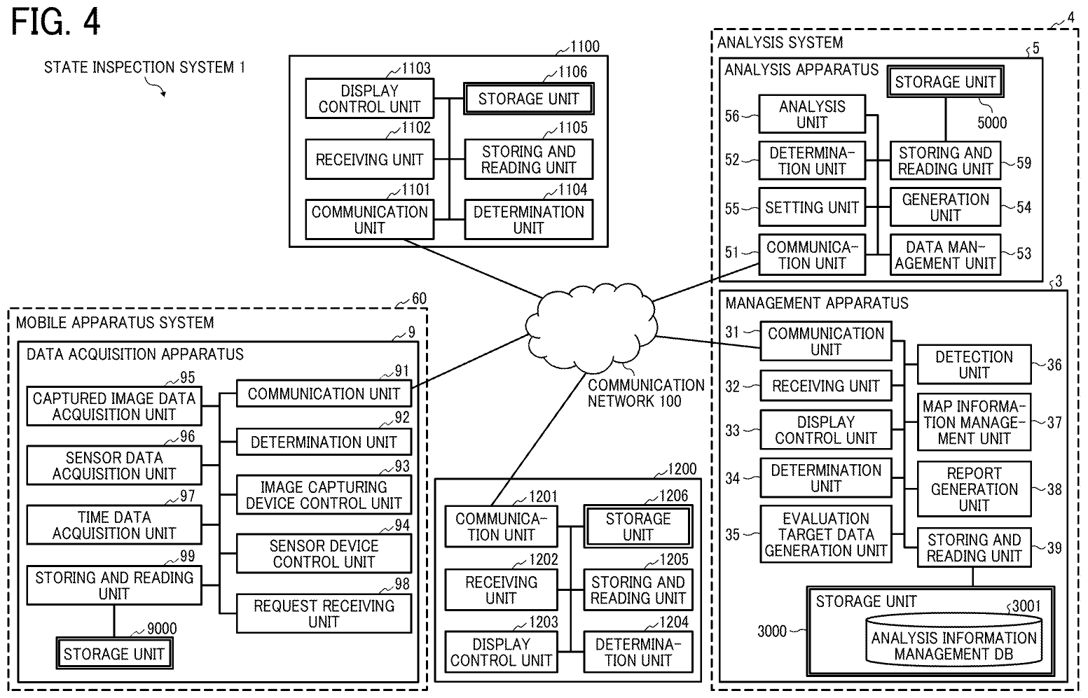

FIG. 4 is a block diagram illustrating an example of a functional configuration of the state inspection system 1, according to the first embodiment. FIG. 4 illustrates a part of the apparatuses or terminals of FIG. 1, which are related to processes or operations described below.

Functional Configuration of Data Acquisition Apparatus

First, an example of a functional configuration of the data acquisition apparatus 9 is described. The data acquisition apparatus 9 includes a communication unit 91, a determination unit 92, an image capturing device control unit 93, a sensor device control unit 94, a captured image data acquisition unit 95, a sensor data acquisition unit 96, a time data acquisition unit 97, a request receiving unit 98, and a storing and reading unit 99.

These units are functions or means implemented by or caused to function by operating one or more hardware components illustrated in FIG. 2 in cooperation with instructions of the CPU 911 according to the program for the data acquisition apparatus loaded from the HD 914 to the RAM 913. The data acquisition apparatus 9 further includes a storage unit 9000 implemented by the ROM 912 and the HD 914 illustrated in FIG. 2. The external PC 930 illustrated in FIG. 2 connected to the data acquisition apparatus 9 includes a receiving unit and a display control unit.

The communication unit 91 is mainly implemented by the network I/F 916 that operates according to instructions of the CPU 911. The communication unit 91 communicates various data or information with other apparatuses or terminals through the communication network 100. For example, the communication unit 91 transmits acquired data acquired by the captured image data acquisition unit 95 and the sensor data acquisition unit 96 to the analysis apparatus 5. The communication unit 91 is an example of transmitting means and receiving means. The determination unit 92, which is implemented by instructions of the CPU 911, performs various determinations.

The image capturing device control unit 93 is mainly implemented by the image capturing device I/F 901 that operates according to instructions of the CPU 911. The image capturing device control unit 93 control photographing processing by the image capturing device 7. The sensor device control unit 94 is mainly implemented by the sensor device I/F 902 that operates according to instructions of the CPU 911. The sensor device control unit 94 controls data acquisition processing for the sensor device 8.

The captured image data acquisition unit 95 is mainly implemented by the image capturing device I/F 901 that operates according to instructions of the CPU 911. The captured image data acquisition unit 95 acquires brightness image data and parallax image data from the image capturing device 7. The captured image data acquisition unit 95 can acquire, for example, an image required to form a stereo image of the road surface R in the road width direction in response to, for example, one photographing trigger from the image capturing device control unit 93.

The sensor data acquisition unit 96 is mainly implemented by the sensor device I/F 902 that operates according to instructions of the CPU 911. The sensor data acquisition unit 96 acquires sensor data, which is a result of detection by the sensor device 8. The sensor data acquisition unit 96 is an example of a distance information acquisition unit and a location information acquisition unit. The time data acquisition unit 97 is mainly implemented by the timer 924 that operates according to instructions of the CPU 911. The time data acquisition unit 97 acquires time data that indicates a time at which the captured image data acquisition unit 95 or the sensor data acquisition unit 96 acquires data.

The request receiving unit 98 is mainly implemented by the external device connection I/F 923 that operates according to instructions of the CPU 911. The request receiving unit 98 receives a request from, for example, the external PC 930.

The storing and reading unit 99, which is implemented mainly by instructions of the CPU 911, stores various data (or information) in the storage unit 9000 or reads various types of data (or information) from the storage unit 9000.

Functional Configuration of Management Apparatus

Next, a functional configuration of the management apparatus 3 is described. The management apparatus 3 includes a communication unit 31, a receiving unit 32, a display control unit 33, a determination unit 34, an evaluation target data generation unit 35, a detection unit 36, a map data management unit 37, a report generation unit 38, and a storing and reading unit 39. These units are functions or means implemented by or caused to function by operating one or more hardware components illustrated in FIG. 3 in cooperation with instructions of the CPU 301 according to the program for the management apparatus 3 loaded from the HD 304 to the RAM 303. The management apparatus 3 further includes a storage unit 3000 implemented by the ROM 302 and the HD 304 illustrated in FIG. 3.

The communication unit 31 is mainly implemented by the network I/F 309 that operates according to instructions of the CPU 301. The communication unit 31 communicates various data or information with other apparatuses or terminals through the communication network 100. For example, the communication unit 31 transmits and receives various data relating to analysis of a road surface state to and from the analysis apparatus 5. The communication unit 31 is an example of transmitting means and receiving means.

The receiving unit 32 is mainly implemented by the keyboard 311 or the pointing device 312 that operates according to instructions of the CPU 301. The receiving unit 32 receives various selections or inputs from a user. The receiving unit 32 receives various selections or inputs to the display 306. The display control unit 33, which is mainly implemented by the instructions of the CPU 301, controls the display 306 to display various images. The determination unit 34, which is implemented by instructions of the CPU 301, performs various determinations. The receiving unit 32 is an example of operation receiving means.

The evaluation target data generation unit 35, which is implemented by instructions of the CPU 301, generates data to be evaluated. In the following description, the data to be evaluated may be referred to “evaluation target data.” The detection unit 36, which is mainly implemented by instructions of the CPU 301, performs processing of detecting a state of the road surface using the evaluation target data generated by the evaluation target data generation unit 35. The map data management unit 37, which is mainly implemented by instructions of the CPU 301, manages map information acquired from, for example, an external server. The map information includes location information at a certain position on a map.

The report generation unit 38, which is mainly implemented by instructions of the CPU 301, generates an evaluation report to be submitted to the entity in charge of roads based on the evaluation result.

The storing and reading unit 39 is implemented mainly by processing of the CPU 301 and stores various types of data or information in the storage unit 3000 or reads out various types of data or information from the storage unit 3000. The storing and reading unit 39 is an example of updating means.

Functional Configuration of Analysis Apparatus

Next, a functional configuration of the analysis apparatus 5 is described. The analysis apparatus 5 includes a communication unit 51, a determination unit 52, a data management unit 53, a generation unit 54, a setting unit 55, an analysis unit 56, and a storing and reading unit 59. These units are functions or means implemented by or caused to function by operating one or more hardware components illustrated in FIG. 3 in cooperation with instructions of the CPU 501 according to the program for the analysis apparatus loaded from the HD 504 to the RAM 503. The analysis apparatus 5 further includes a storage unit 5000 implemented by the ROM 502 and the HD 504 illustrated in FIG. 3.

The communication unit 51 is mainly implemented by the network I/F 509 that operates according to instructions of the CPU 501. The communication unit 51 communicates various data or information with other apparatuses or terminals through the communication network 100. For example, the communication unit 51 receives captured image data and sensor data transmitted from the data acquisition apparatus 9. Further, the communication unit 51 transmits and receives various data to and from the management apparatus 3, for example. The communication unit 51 is an example of transmitting means and receiving means. The determination unit 52, which is implemented by instructions of the CPU 501, performs various determinations. The determination unit 52 is an example of position generation means.

The data management unit 53, which is mainly implemented by instructions of the CPU 501, manages various data relating to the evaluation of a road surface state. For example, the data management unit 53 registers the captured image data and the sensor data transmitted from the data acquisition apparatus 9 in acquired data management database (DB) 5001. Further, the data management unit 53 registers, for example, data processed or generated by the management apparatus 3 in a processed data management DB 5003. The generation unit 54, which is mainly implemented by instructions of the CPU 501, generates image data relating to a road surface.

The generation unit 54, which is implemented by instructions of the CPU 301, performs various types of generation. The setting unit 55, which is implemented by instructions of the CPU 301, configures various settings. The analysis unit 56, which is implemented by instructions of the CPU 301, performs various types of analysis.

The storing and reading unit 59, which is implemented mainly by instructions of the CPU 501, stores various data (or information) in the storage unit 5000 or reads various types of data (or information) from the storage unit 5000.

Functional Configuration of Communication Terminal

Next, a functional configuration of the communication terminal 1100 is described. The communication terminal 1100 includes a communication unit 1101, a receiving unit 1102, a display control unit 1103, a determination unit 1104, and a storing and reading unit 1105. These units are functions or means implemented by or caused to function by operating one or more hardware components illustrated in FIG. 3 in cooperation with instructions of the CPU according to the program for the communication terminal loaded from the HD to the RAM. The communication terminal 1100 further includes a storage unit 1106 implemented by the ROM and the HD illustrated in FIG. 3.

The communication unit 1101 is mainly implemented by the network I/F that operates according to instructions of the CPU. The communication unit 1101 communicates various data or information with other apparatuses or terminals through the communication network 100. The communication unit 1101 is an example of transmitting means and receiving means.

The receiving unit 1102 is mainly implemented by the keyboard or the pointing device that operates according to instructions of the CPU. The receiving unit 1102 receives various selections or inputs from a user. The display control unit 1103, which is mainly implemented by the instructions of the CPU, controls the display to display various images. The determination unit 1104, which is implemented by instructions of the CPU 301, performs various determinations. The receiving unit 1102 is an example of operation receiving means.

The storing and reading unit 1105, which is implemented mainly by instructions of the CPU, stores various data (or information) in the storage unit 1106 or reads various types of data (or information) from the storage unit 1106.

Next, a functional configuration of the communication terminal 1200 is described. The communication terminal 1200 includes a communication unit 1201, a receiving unit 1202, a display control unit 1203, a determination unit 1204, and a storing and reading unit 1205. These units are functions or means implemented by or caused to function by operating one or more hardware components illustrated in FIG. 3 in cooperation with instructions of the CPU according to the program for the communication terminal loaded from the HD to the RAM. The communication terminal 1200 further includes a storage unit 1206 implemented by the ROM and the HD illustrated in FIG. 3.

The communication unit 1201 is mainly implemented by the network I/F that operates according to instructions of the CPU. The communication unit 1201 communicates various data or information with other apparatuses or terminals through the communication network 100.

The receiving unit 1202 is mainly implemented by the keyboard or the pointing device that operates according to instructions of the CPU. The receiving unit 1202 receives various selections or inputs from a user. The display control unit 1203, which is mainly implemented by the instructions of the CPU, controls the display to display various images. The determination unit 1204, which is implemented by instructions of the CPU 301, performs various determinations.

The storing and reading unit 1205, which is implemented mainly by instructions of the CPU, stores various data (or information) in the storage unit 1206 or reads various types of data (or information) from the storage unit 1206.

Analysis Information Management Table

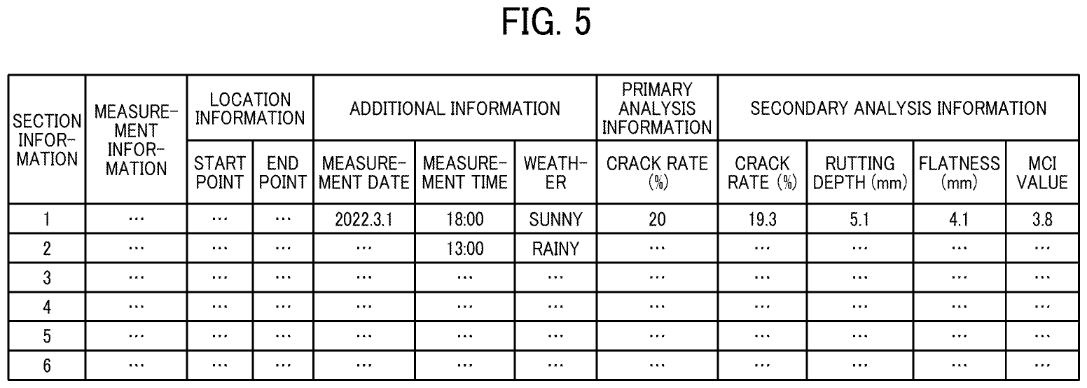

FIG. 5 is a conceptual diagram illustrating an example of an analysis information management table. The analysis information management table is a table for managing primary analysis information and secondary analysis information obtained by analyzing measurement information. In the storage unit 3000, an analysis information management DB 3001 is stored, for example, in the form of an analysis information management table as illustrated in FIG. 5. In the analysis information management table, measurement information, location information, additional information, the primary analysis information, and the secondary analysis information are managed in association with each other for each section information.

The measurement information includes the brightness image data captured by each of the first camera 71 and the second camera 72 of the image capturing device 7 and the parallax image data indicating parallax information by the first camera 71 and the second camera 72.

The location information includes location information of a start point and location information of an end point between which the measurement information is acquired. The additional information includes a measurement date and a measurement time when the measurement information is measured, and weather at the corresponding time.

The primary analysis information is numerical information indicating cracks or the like analyzed by, for example, artificial intelligence (AI) analysis without human intervention. The secondary analysis information is obtained by manual analysis in addition to the automatic analysis. The secondary analysis information is different from the primary analysis information in that higher accuracy is achieved by manual operation or inclusion of more detailed information, and that the number of analysis items is larger than the primary analysis information. Examples of the inclusion of the detailed information include that a crack rate in the primary analysis is output on the basis of the counted number of cracks, whereas in the secondary analysis, the crack rate is output using not only the information on the counted number of cracks but also information on a counted area of patching (partial repair tracks) according to the handbook of test methods. Examples of the analysis items include, but are not limited to the crack rate, rutting depth, flatness, IRI, and Maintenance Control Index (MCI).

Processes or Operation of Embodiment

Operation of Acquiring Data

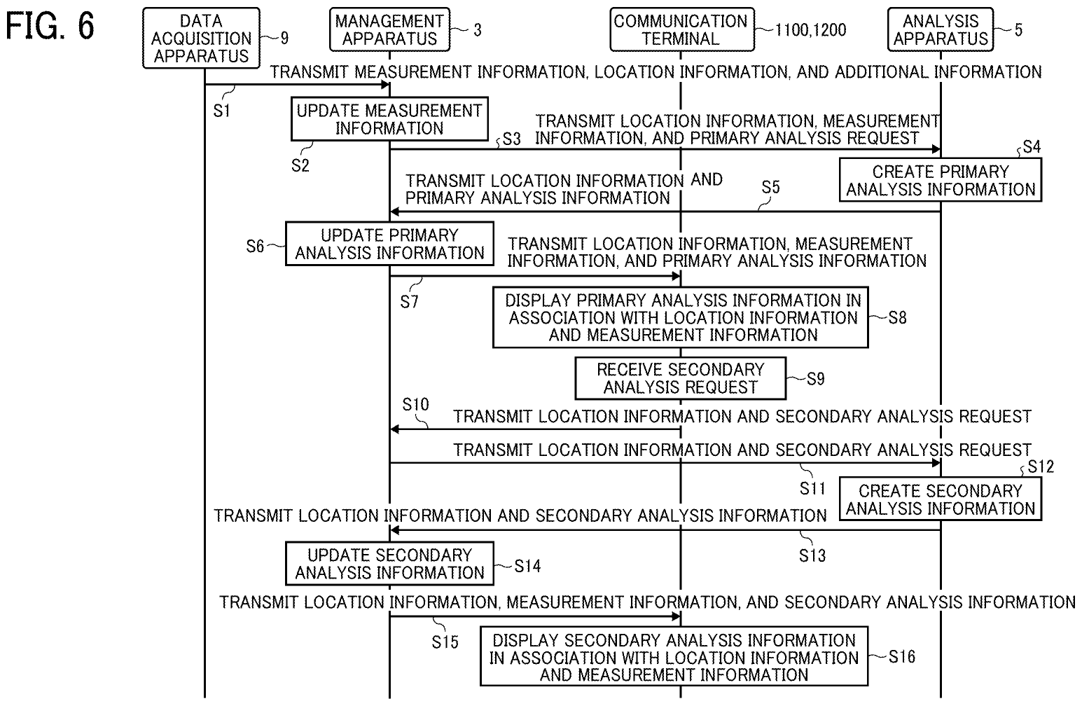

FIG. 6 is a sequence diagram illustrating an example of an operation of analyzing data.

In the following, in regard to operations performed by the communication terminal 1100 and the communication terminal 1200, an operation by the communication terminal 1100 is described. The communication terminal 1200 performs the same or substantially the same operation as described with reference the communication terminal 1100.

The communication unit 91 of the data acquisition apparatus 9 transmits, to the management apparatus 3, the measurement information, the location information, and the additional information, which are associated with each other (step S1). The communication unit 31 of the management apparatus 3 receives these information items. Step S1 is an example of a receiving step.

When location information and measurement information corresponding to the location information and the measurement information received in step S1 are not stored in the analysis information management DB 3001, the storing and reading unit 39 stores the measurement information received in step S1 in association with the location information and the additional information received in step S1 in the analysis information management DB 3001.

When location information and measurement information corresponding to the location information and the measurement information received in step S1 are already stored in the analysis information management DB 3001 and satisfies a predetermined condition, the storing and reading unit 39 stores the measurement information received in step S1 in association with the location information and the additional information received in step S1 in the analysis information management DB 3001 to update the stored information (step S2).

The communication unit 31 transmits the measurement information stored or updated in step S2 to the analysis apparatus 5 in association with the location information and a primary analysis request, and the communication unit 51 of the analysis apparatus 5 receives these information items (step S3).

The analysis unit 56 performs primary analysis on the measurement information received in step S3 according to the primary analysis request received in step S3, to store primary analysis information in the storage unit 5000 in association with the location information and the measurement information (step S4).

The communication unit 51 transmits the primary analysis information obtained by analyzing the measurement information in step S4 to the management apparatus 3 in association with the location information received in step S3, and the communication unit 31 of the management apparatus 3 receives these information items (step S5).

When location information and primary analysis information corresponding to the location information and the primary analysis information received in step S5 are not stored in the analysis information management DB 3001, the storing and reading unit 39 stores the primary analysis information received in step S5 in the analysis information management DB 3001 in association with the location information received in step S5.

When location information and primary analysis information corresponding to the location information and the primary analysis information received in step S5 are already stored in the analysis information management DB 3001, the storing and reading unit 39 stores the primary analysis information received in step S5 in the analysis information management DB 3001 in association with the location information received in step S5 to update the stored information (step S6). Step S6 is an example of a storing step and an updating step.

The communication unit 31 transmits the primary analysis information stored or updated in step S6 to the communication terminal 1100 in association with the location information and the measurement information, and the communication unit 1101 of the communication terminal 1100 receives these information items (step S7).

The display control unit 1203 controls the display to display the primary analysis information received in step S7 in association with the location information and the measurement information (step S8). The receiving unit 1102 receives a secondary analysis request with respect to the primary analysis information displayed in step S8 (step S9). Step S8 is an example of a displaying step. Step S9 is an example of an accepting step.

The display control unit 1203 may display the primary analysis information and the measurement information at a position corresponding to the location information on a map displayed on the display. The display control unit 1203 may display the updated primary analysis information and the updated measurement information in a manner that they are distinguished from other primary analysis information and measurement information.

The communication unit 1101 transmits the secondary analysis request received in step S9 to the management apparatus 3 in association with the location information, and the communication unit 31 of the management apparatus 3 receives these information items (step S10). Step S10 is an example of a receiving step.

The communication unit 31 transmits the secondary analysis request and the location information received in step S10 to the analysis apparatus 5, and the communication unit 51 of the analysis apparatus 5 receives these information items (step S11).

According to the secondary analysis request and the location information received in step S11, the analysis unit 56 performs secondary analysis on the measurement information stored in the storage unit 5000 in association with the location information in step S4, to store secondary analysis information in the storage unit 5000 in association with the location information and the measurement information (step S12).

The communication unit 51 transmits the secondary analysis information obtained by analyzing the measurement information in step S12 to the management apparatus 3 in association with the location information received in step S11, and the communication unit 31 of the management apparatus 3 receives these information items (step S13).

When location information and secondary analysis information corresponding to the location information and the secondary analysis information received in step S13 are not stored in the analysis information management DB 3001, the storing and reading unit 39 stores the secondary analysis information received in step S13 in the analysis information management DB 3001 in association with the location information received in step S13.

When location information and secondary analysis information corresponding to the location information and the secondary analysis information received in step S13 are already stored in the analysis information management DB 3001, the storing and reading unit 39 stores the secondary analysis information received in step S13 in the analysis information management DB 3001 in association with the location information received in step S13 to update the stored information (step S14).

The communication unit 31 transmits the secondary analysis information stored or updated in step S14 to the communication terminal 1100 in association with the location information and the measurement information, and the communication unit 1101 of the communication terminal 1100 receives these information items (step S15).

The display control unit 1203 displays the secondary analysis information received in step S15 on the display in association with the location information and the measurement information (step S16).

The display control unit 1203 may display the secondary analysis information and the measurement information at a position corresponding to the location information on a map displayed on the display. The display control unit 1203 may display the updated secondary analysis information in a manner that it is distinguished from other secondary analysis information.

Although the description given above is of an example in which the analysis apparatus 5 and the management apparatus 3 are separately provided, in another example, the analysis apparatus and the management apparatus are provided as a single entity. In this case, the processes of steps S3, S5, S11, and S13 relating to transmission and reception are omitted, and the processes of steps S4 and S12 are performed by the analysis unit by an analysis unit of the management apparatus 3.

In another example, the communication terminal 1100 or the communication terminal 1200 and the management apparatus 3 are provided as a single entity. In this case, the processes of steps S7, S10, and S15 relating to transmission and reception are omitted, the processes of steps S8 and S16 are performed by the display control unit 33, and the process of step S9 is performed by the receiving unit 32.

As described above, the management apparatus 3 manages the primary analysis information obtained by analyzing the measurement information obtained by measuring the road surface R according to no analysis request and the secondary analysis information obtained by analyzing the measurement information on the basis of the primary analysis information according to an analysis request. Accordingly, compared to the case of measuring the road surface R after receiving an analysis request, analysis information can be obtained timely. Further, compared to the case of analyzing the road surface in advance with the final quality before receiving an analysis request, analysis information can be obtained efficiently for measurement information for which analysis information is required.

In particular, in a case that a general-purpose vehicle such as a parcel delivery vehicle is used as the mobile apparatus 6, the road surface R can be easily measured before receiving an analysis request without the cost of a dedicated vehicle. Accordingly, compared to a case of analyzing with the final quality, the primary analysis information can be easily obtained by using AI or the like or analyzing simple contents.

Thus, a user can appropriately determine whether to make an analysis request on the basis of the updated primary analysis information, compared to a case that the user determines whether to make an analysis request on the basis of the primary analysis information which is not updated.

In other words, even when whether to make an analysis request cannot be determined on the basis of old primary analysis information, whether to make an analysis request is determined on the basis of updated primary analysis information.

Further, the management apparatus 3 transmits the updated primary analysis information, and therefore the user can check the updated primary analysis information received by the communication terminal 1100 and the communication terminal 1200 and appropriately determine whether to give an analysis request. Thus, the management apparatus 3 can receive an appropriate analysis request based on the updated primary analysis information.

Further, the display control unit 33 displays the primary analysis information on the display 306, and thus the user can appropriately determine whether to make an analysis request.

In other words, it is difficult for a user to determine whether to make an analysis request by simply checking the measurement information unless the user is a very skilled person. The configuration described above allows a user to appropriately determine whether to make the analysis request by checking the primary analysis information obtained by simply analyzing the measurement information.

The display control unit 33 controls the display 306 to display the measurement information and the primary analysis information in association with each other, thus the user can more appropriately determine whether to make an analysis request.

Further, the display control unit 33 controls the display 306 to display the updated primary analysis information, and therefore a user can check the updated primary analysis information and appropriately determine whether to make an analysis request. Thus, the receiving unit 32 can receive an appropriate analysis request based on the updated primary analysis information.

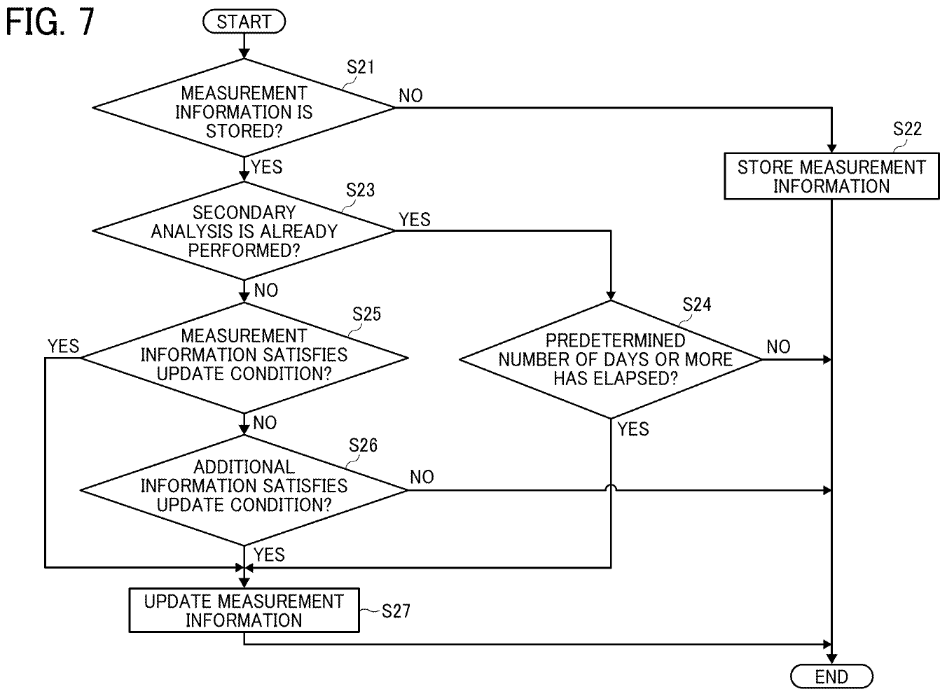

FIG. 7 is a flowchart illustrating an example of an operation of updating measurement information. FIG. 7 illustrates specific processing corresponding to step S2 of FIG. 6.

When the determination unit 34 determines that location information and measurement information corresponding to the location information and the measurement information received in step S1 are not stored in the analysis information management DB 3001 (step S21: No), the storing and reading unit 39 stores the measurement information received in step S1 in association with the location information and the additional information received in step S1 in the analysis information management DB 3001 (step S22).

By contrast, when the determination unit 34 determines that location information and measurement information corresponding to the received location information and the received measurement information are already stored in the analysis information management DB 3001 (step S21: Yes), the determination unit 34 determines whether secondary analysis information associated with the location information received in step S1 is stored in the analysis information management DB 3001 (step S23).

As a result, new measurement information is stored or existing measurement information is updated according to a location of the road surface R. Thus, new primary analysis information is stored or existing primary analysis information is updated according to a location of the road surface R.

When the determination unit 34 determines that the secondary analysis information is already stored in the analysis information management DB 3001 (step S23: Yes), the determination unit 34 determines whether a measurement date of the measurement information received in step S1 has passed by a predetermined number of days or more with respect to a measurement date of the measurement information corresponding to the secondary analysis information stored in the analysis information management DB 3001 (step S24).

When the determination unit 34 determines that the predetermined number of days or more has not passed (step S24: No), the operation ends. When the determination unit 34 determines that the predetermined number of days or more has passed (step S24: Yes), the storing and reading unit 39 stores the measurement information received in step S1 in the analysis information management DB 3001 in association with the location information and the additional information received in step S1 to update the already stored measurement information (step S27).

As a result, in a case that the measurement date of the measurement information received in step S1 has not passed by a predetermined number of days or more with respect to the measurement date of the measurement information corresponding to the already stored secondary analysis information, the possibility that the road surface R has deteriorated over time is considered to be low and the measurement information is not updated. Thus, unnecessary analysis of the primary analysis information and the update are avoided.

By contrast, in a case that the measurement date of the measurement information received in step S1 has passed by a predetermined number of days or more with respect to the measurement date of the measurement information corresponding to the already stored secondary analysis information, the possibility that the road surface R has deteriorated is considered to be high, and the measurement information is updated. Thus, the deterioration of the road surface over time is checked from the primary analysis information.

When the measurement information is updated in step S27, the primary analysis information is also updated as described with respect to steps S2 to S6 of FIG. 6.

When the determination unit 34 determines that the secondary analysis information is not stored in the analysis information management DB 3001 (step S23: No), the determination unit 34 determines whether the measurement information received in step S1 satisfies a predetermined update condition (step S25).

When the determination unit 34 determines that the measurement information satisfies the update condition (step S25: Yes), the operation proceeds to step S27. The storing and reading unit 39 stores the measurement information received in step S1 in association with the location information and the additional information received in step S1 in the analysis information management DB 3001, to update the measurement information.

As a result, when the received additional information satisfies the predetermined update condition, the measurement information is updated and thereby the primary analysis information is analyzed and updated.

Specifically, in a case that a measurement time of the measurement information received in step S1 is a daytime while a measurement time of the measurement information already stored is evening, the update condition is determined to be satisfied on the assumption that the measurement accuracy is higher in the daytime.

Further, in a case that the weather at the time of measurement of the measurement information received in step S1 is fine while the weather at the time of measurement of the already stored measurement information is rainy, the update condition is determined to be satisfied on the assumption that the measurement accuracy is better in fine weather.

In other words, by updating to accurate measurement information, accurate primary analysis information is analyzed.

By contrast, when the determination unit 34 determines that the measurement information does not satisfy the update condition (step S25: No), the determination unit 34 determines whether the additional information received in step S1 satisfies a predetermined update condition (step S26).

When the determination unit 34 determines that the additional information satisfies the update condition (step S26: Yes), the operation proceeds to step S27. The storing and reading unit 39 stores the measurement information received in step S1 in the analysis information management DB 3001 in association with the location information and the additional information received in step S1 to update the measurement information. When the determination unit 34 determines that the additional information does not satisfy the update condition (step S26: No), the operation ends.

According to one or more embodiments of the present disclosure, measurement information is appropriately analyzed.

Aspect 1-1

As described above, the communication terminal 1100 and the communication terminal 1200 according to an embodiment of the present disclosure include the display control unit 1103 and the display control unit 1203, each controlling the display to display primary analysis information obtained by analyzing measurement information obtained by measuring the road surface R without an analysis request, and the receiving unit 1102 and the receiving unit 1202, each receiving an analysis request that requests secondary analysis information of the measurement information corresponding to the primary analysis information.

The road surface R is an example of an object and an example of a structure. The communication terminal 1100 and the communication terminal 1200 are examples of an information processing apparatus. The information processing apparatus may be configured by the management apparatus 3.

As a result, compared to a case that the object is measured after the analysis request is received, the primary analysis information can be obtained timely. Further, compared to a case that an object is analyzed in advance with the final quality before the analysis request is received, and the secondary analysis information is obtained efficiently for measurement information that requires further analysis on the basis of the primary analysis information. In other words, since a user can select an object for which the secondary analysis is to be performed after checking the primary analysis information, convenience for the user is enhanced in determining which object is to be selected.

Aspect 1-2

In the communication terminal 1100 and the communication terminal 1200 according to the Aspect 1-1, each of the display control unit 1103 and the display control unit 1203 further controls the display to display the secondary analysis information based on the analysis request.

Due to such a configuration, a user can check a result of the secondary analysis on the communication terminal 1100 and the communication terminal 1200. This enhances convenience for the user.

Aspect 1-3

In the communication terminal 1100 and the communication terminal 1200 according to the Aspect 1-1 or Aspect 1-2, each of the display control unit 1103 and the display control unit 1203 further controls the display to display location information indicating a location at which the object corresponding to the primary analysis information is measured.

Due to such a configuration, a user can visually recognize a location or a time where and when an object is measured. This enhances convenience for the user when selecting a desired object for which the user wants to obtain the secondary analysis result.

Aspect 1-4

In the communication terminal 1100 and the communication terminal 1200 according to the Aspect 1-3, each of the display control unit 1103 and the display control unit 1203 controls the display to display the map information in association with the location information.

Due to such a configuration, a user can visually recognize a location or a time where or when the object is measured as the map information. This enhances convenience for the user when recognizing the location of the object.

Aspect 1-5

The management apparatus 3 according to an embodiment of the present invention includes the storing and reading unit 39 that stores primary analysis information obtained by analyzing measurement information obtained by measuring an object without an analysis request in the analysis information management DB 3001, and a communication unit 31 that transmits the primary analysis information to communication terminal 1100 and the communication terminal 1200. The communication unit 31 receives an analysis request that requests secondary analysis information of the measurement information corresponding to the primary analysis information from the communication terminal 1100 and the communication terminal 1200.

The analysis information management DB 3001 is an example of storage means. The storing and reading unit 39 is an example of storage control means. The communication unit 31 is an example of transmitting means and receiving means.

Due to such a configuration, when the management apparatus 3 requests secondary analysis, the management apparatus recognizes primary analysis information for which a user wants secondary analysis. This reduces processing load of secondary analysis.

Aspect 1-6

In the management apparatus 3 according to the Aspect 1-5, the communication unit 31 further transmits the received analysis request to the analysis apparatus 5 and receives the secondary analysis information analyzed according to the analysis request from the analysis apparatus 5.

Due to such a configuration, when the analysis apparatus 5 performs secondary analysis, the analysis apparatus recognizes primary analysis information for which a user wants secondary analysis. This reduces processing load of secondary analysis.

Aspect 1-7

In the management apparatus 3 according to the Aspect 1-6, the communication unit 31 further transmits the secondary analysis information to the communication terminal 1100 and the communication terminal 1200.

Due to such a configuration, a user can visually recognize only the secondary analysis information for which the user wants analysis. This enhances convenience for the user and reduces processing load of secondary analysis.

Aspect 1-8

In the management apparatus 3 according to the Aspect 1-7, the communication unit 31 further transmits location information indicating a location where the object corresponding to the primary analysis information is measured to the communication terminal 1100 and the communication terminal 1200.

Due to such a configuration, when a user visually checks the secondary analysis information, the user can also visually recognize a location or a time where and when an object is measured. This enhances convenience for the user.

Aspect 2-1

The management apparatus 3 according to an embodiment of the present disclosure manages primary analysis information obtained by analyzing measurement information obtained by measuring the road surface R without analysis request and secondary analysis information obtained by analyzing the measurement information on the basis of the primary analysis information and the analysis request. The management apparatus 3 includes the communication unit 31 that receives the measurement information transmitted by the data acquisition apparatus 9, and the storing and reading unit 39 that updates the primary analysis information on the basis of the measurement information received by the communication unit 31.

The road surface R is an example of an object and an example of a structure. The data acquisition apparatus 9 is an example of a measurement apparatus. The communication unit 31 is an example of receiving means. The storing and reading unit 39 is an example of updating means.

It is preferable that the secondary analysis information has more analysis items or a finer analysis degree than the primary analysis information. The primary analysis information may be analyzed by AI analysis or the like without human intervention. The secondary analysis information may be manually analyzed.

Due to such a configuration, the secondary analysis information is analyzed on the basis of the updated primary analysis information, compared to the analysis based on the primary analysis information that is not updated. That is, even if it is not possible to determine the necessity of secondary analysis based on old primary analysis information, it is possible to determine the necessity of secondary analysis based on updated primary analysis information.

Aspect 2-2

In the management apparatus 3 according to the Aspect 2-1, the storing and reading unit 39 updates the primary analysis information on the basis of an elapsed time from measurement of the measurement information in the past to measurement of the measurement information received by the communication unit 31. Thus, the primary analysis information is analyzed when the object is deteriorated over time.

Aspect 2-3

In the management apparatus 3 according to the Aspect 2-1 or the Aspect 2-2, when the secondary analysis information corresponding to the measurement information received by the communication unit 31 is already analyzed, the storing and reading unit 39 does not update the primary analysis information. Thus, unnecessary analysis of the primary analysis information is avoided.

Aspect 2-4

In the management apparatus 3 according to any one of the Aspect 2-1 to the Aspect 2-3, the storing and reading unit 39 updates the primary analysis information when the measurement information received by the communication unit 31 satisfies a predetermined update condition.

Due to such a configuration, the primary analysis information is updated in a case that the received measurement information is more accurate than the old measurement information or in a case that the received measurement information covers a wider measurement area than the old measurement information.

Aspect 2-5

In the management apparatus 3 according to any one of the Aspect 2-1 to the Aspect 2-4, the communication unit 31 receives additional information that is transmitted by the data acquisition apparatus 9 in association with the measurement information, and the storing and reading unit 39 updates the primary analysis information on the basis of the additional information.

Due to such a configuration, on the basis of weather information as an example of the additional information, the primary analysis information is updated in a case that weather when the received measurement information is measured is better than weather when the old measurement information is measured.

Aspect 2-6

In the management apparatus 3 according to any one of the Aspect 2-1 to the Aspect 2-5, the communication unit 31 receives location information indicating a location of the road surface R that is transmitted by the data acquisition apparatus 9 in association with the measurement information, and the storing and reading unit 39 updates the primary analysis information on the basis of the location information. Thus, the primary analysis information is updated for each piece of location information.

Aspect 2-7

In the management apparatus 3 according to any one of the Aspect 2-1 to Aspect 2-6, the communication unit 31 is an example of transmitting means, and transmits the primary analysis information to the communication terminal 1100 and the communication terminal 1200. The communication unit 31 receives an analysis request that requests creation of secondary analysis information corresponding to the transmitted primary analysis information from the communication terminal 1100 and the communication terminal 1200.

Due to such a configuration, compared to a case that the primary analysis information that is not updated is transmitted, an appropriate analysis request based on the updated primary analysis information is received. In other words, even when whether to make an analysis request cannot be determined at the terminal on the basis of old primary analysis information, whether to make an analysis request is determined on the basis of updated primary analysis information.

Aspect 2-8

The management apparatus 3 according any one of the Aspect 2-1 to the Aspect 2-6 includes the display control unit 33 that controls the display 306, which is an example of a display unit, to display the primary analysis information, and the receiving unit 32 that receives an analysis request that requests creation of the secondary analysis information corresponding to the primary analysis information displayed on the display 306.

Due to such a configuration, compared to a case that the primary analysis information that is not updated is displayed, an appropriate analysis request based on the updated primary analysis information is accepted. In other words, even when whether to make an analysis request cannot be determined on the basis of old primary analysis information, whether to make an analysis request is determined on the basis of updated primary analysis information.

Aspect 2-9

The state inspection system 1, which is an example of an information processing system according to an embodiment of the present disclosure, includes the data acquisition apparatus 9 and the management apparatus 3 communicably connected to the data acquisition apparatus 9. The data acquisition apparatus 9 includes the communication unit 91, which is an example of transmitting means, that transmits measurement information obtained by measuring the road surface R to the management apparatus 3. The management apparatus 3 manages primary analysis information obtained by analyzing the measurement information without an analysis request and secondary analysis information obtained by analyzing the measurement information according to the analysis request. The management apparatus 3 includes the communication unit 31 that receives the measurement information transmitted by the data acquisition apparatus 9, and the storing and reading unit 39 that updates the primary analysis information on the basis of the measurement information received by the communication unit 31.

Aspect 2-10

The state inspection system 1 according to an embodiment of the present disclosure includes the data acquisition apparatus 9, the management apparatus 3 communicably connected to the data acquisition apparatus 9, a communication terminal communicably connected to the management apparatus 3. The data acquisition apparatus 9 includes the communication unit 91 that transmits measurement information obtained by measuring the road surface R to the management apparatus 3. The management apparatus 3 manages primary analysis information obtained by analyzing the measurement information without an analysis request and secondary analysis information obtained by analyzing the measurement information according to the analysis request. The management apparatus 3 includes the communication unit 31 that receives the measurement information transmitted by the data acquisition apparatus 9, and the storing and reading unit 39 that updates the primary analysis information on the basis of the measurement information received by the communication unit 31. The communication unit 31 transmits the primary analysis information to the communication terminal 1100 and the communication terminal 1200 and receives an analysis request that requests creation of secondary analysis information corresponding to the transmitted primary analysis information from the communication terminal 1100 and the communication terminal 1200. The communication terminal 1100 and the communication terminal 1200 respectively include the communication unit 1101 and the communication unit 1201 that receive the primary analysis information transmitted by the management apparatus 3. The communication unit 1101 and the communication unit 1201 transmit the analysis request corresponding to the received primary analysis information to the management apparatus 3.

Aspect 2-11

A management method according to an embodiment of the present disclosure manages primary analysis information obtained by analyzing measurement information obtained by measuring the road surface R without analysis request and secondary analysis information obtained by analyzing the measurement information according to the analysis request. The management method includes a reception step of receiving the measurement information transmitted by the data acquisition apparatus 9 and an update step of updating the primary analysis information on the basis of the measurement information received at the reception step.

Aspect 2-12

A program according to an embodiment of the present disclosure causes a computer to perform the management method according to the Aspect 2-11.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), a system on chip (SOC), graphics processing units (GPUs) conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus, comprising circuitry configured to:
control a display to display primary analysis information obtained by analyzing measurement information without being based on a request for an analysis, the measurement information being obtained by measuring an object; and
accept an analysis request that requests secondary analysis information of the measurement information corresponding to the primary analysis information.

2. The information processing apparatus of claim 1, wherein the circuitry is configured to control the display to display the secondary analysis information obtained by analyzing the measurement information according to the analysis request.

3. The information processing apparatus of claim 1, wherein the circuitry is configured to control the display to display location information indicating a location where the object corresponding to the primary analysis information is measured.

4. The information processing apparatus of claim 3, wherein the circuitry is configured to control the display to display map information in association with the location information.

5. A management apparatus, comprising circuitry configured to:
store, in a memory, primary analysis information obtained by analyzing measurement information without being based on a request for an analysis, the measurement information being obtained by measuring an object;
transmit the primary analysis information to a terminal apparatus; and
receive, from the terminal apparatus, an analysis request that requests secondary analysis information of the measurement information corresponding to the primary analysis information.

6. The management apparatus of claim 5, wherein the circuitry is further configured to:
transmit the received analysis request to an analysis apparatus; and
receive the secondary analysis information obtained by analyzing the measurement information according to the analysis request from the analysis apparatus.

7. The management apparatus of claim 6, wherein the circuitry is further configured to transmit the secondary analysis information to the terminal apparatus.

8. The management apparatus of claim 7, wherein the circuitry is further configured to transmit location information indicating a location where the object corresponding to the primary analysis information is measured to the terminal apparatus.

9. An information processing system, comprising:
a management apparatus; and
a terminal apparatus communicably connected to the management apparatus,
the management apparatus including first circuitry configured to:
store, in a memory, primary analysis information obtained by analyzing measurement information without being based on a request for an analysis, the measurement information being obtained by measuring an object;
transmit the primary analysis information to the terminal apparatus; and
receive, from the terminal apparatus, an analysis request that requests secondary analysis information of the measurement information corresponding to the primary analysis information,
the terminal apparatus including second circuitry configured to:
receive the primary analysis information from the management apparatus;
control a display to display the received primary analysis information;
accept the analysis request; and
transmit the analysis request to the management apparatus.

10. The information processing system of claim 9, further comprising an analysis apparatus, wherein
the first circuitry of the management apparatus is configured to transmit the received analysis request to the analysis apparatus, and
the analysis apparatus includes third circuitry configured to:
receive the analysis request from the management apparatus;
perform secondary analysis on the measurement information according to the analysis request; and
transmit the secondary analysis information obtained by the secondary analysis to the management apparatus.

11. The management apparatus of claim 5, wherein
the circuitry is configured to:
manage the primary analysis information and the secondary analysis information;
receive the measurement information transmitted by a measurement apparatus; and
update the primary analysis information based on the measurement information received from the measurement apparatus.

12. The management apparatus of claim 11, wherein the circuitry is configured to update the primary analysis information based on an elapsed time from a time when the measurement information is measured in the past to a time when the measurement information is measured.

13. The management apparatus of claim 11, wherein the circuitry is configured to omit updating the primary analysis information in a case that the secondary analysis information corresponding to the received measurement information is already analyzed.

14. The management apparatus of claim 11, wherein the circuitry is configured to update the primary analysis information in a case that the received measurement information satisfies a predetermined update condition.

15. The management apparatus of claim 11, wherein the circuitry is configured to:
receive additional information that is transmitted by the measurement apparatus in association with the measurement information; and
update the primary analysis information based on the additional information.

16. The management apparatus of claim 11, wherein the circuitry is configured to:
receive location information indicating a location of the object, the location information being transmitted by the measurement apparatus in association with the measurement information; and
update the primary analysis information based on the location information.

17. The information processing system of claim 9, wherein the first circuitry of the management apparatus is configured to:
manage the primary analysis information and the secondary analysis information;
receive the measurement information transmitted by a measurement apparatus; and
update the primary analysis information based on the received measurement information.

18. The information processing system of claim 17, wherein the first circuitry of the management apparatus is configured to update the primary analysis information based on an elapsed time from when the measurement information is measured in the past until when the measurement information is measured.

19. The information processing system of claim 17, wherein the first circuitry of the management apparatus is configured to:
receive additional information that is transmitted by the measurement apparatus in association with the measurement information; and
update the primary analysis information based on the additional information.

20. The information processing system of claim 17, wherein the first circuitry of the management apparatus is configured to:
receive location information indicating a location of the object, the location information being transmitted by the measurement apparatus in association with the measurement information; and
update the primary analysis information based on the location information.
